(19) United States
(12) Patent Application Publication
(10) Pub. No.: US 2009/0222904 A1
(43) Pub. Date: Sep. 3, 2009

(54) NETWORK ACCESS NODE COMPUTER FOR A COMMUNICATION NETWORK, COMMUNICATION SYSTEM AND METHOD FOR OPERATING A COMMUNICATION SYSTEM

(75) Inventor: Uwe Schmidtke, Greifswald (DE)

Correspondence Address: LERNER GREENBERG STEMER LLP, P O BOX 2480, HOLLYWOOD, FL, 33022-2480, US

(73) Assignee: Nokia Siemens Networks GmbH & Co.KG, Muchen (DE)

(21) Appl. No.: 12/088,839

(22) PCT Filed: Aug. 28, 2006
(86) PCT No.: PCT/EP2006/065714

§ 371 Date: Aug. 22, 2008

(30) Foreign Application Priority Data
Sep. 30, 2005 (DE) 102005046935.3

(51) Int. Cl. H04L 29/06; H04L 12/58; H04L 12/22

(52) U.S. Cl. 726/11; 726/3; 726/3; 726/24

(57) ABSTRACT

The invention relates to a network access remote front-end processor (20) for a communication network (10) which is connectable to communication network (10) by means of a communication line (11), to a subscriber component (30.1, . . . , 30.n) by means of at least one subscriber line (31.1, . . . , 31.n) and which is configured for transporting a data flow between the communication network (10) and at least one subscriber component (30.1, . . . , 30.n), wherein the inventive network access remote front-end processor (20) comprises a protection device (21) through which the data flow can be directed and which is configured for detecting, analysing and modifying the data flow in the presence of predefined conditions.

### CLAIM FOR PRIORITY

This application is a national stage application of PCT/EP2006/065714, filed Aug. 28, 2006, which claims the benefit of priority to German Application No. 10 2005 046 935.3, filed Sep. 30, 2005, the contents of which hereby incorporated by reference.

### TECHNICAL FIELD OF THE INVENTION

The invention relates to a network access node computer for a communication network, to a communication system and to a method for operating a communication system.

### BACKGROUND OF THE INVENTION

In a conventional communication system, a plurality of subscriber components are coupled to a network access node computer by means of respective subscriber lines, said network access node computer setting up the connection between the subscriber components and a communication network. By way of example, the communication network is a multiplicity of computers coupled to one another which communicate with one another on the basis of the Internet protocol (IP). Such a communication network is also referred to as the Internet. The ever more frequent use of the Internet by the subscriber components, which are constantly or else only intermittently connected to the communication network via the network access node computer, means that security is an ever more important subject complex.

The subscriber components need to be protected against the following listed threats which come from the communication network: viruses, worms, Trojan horses, denial of service attacks (DoS attacks), such as IP spoofing, SynFlood attacks and also unsolicited bulk e-mail (UBE), such as spam e-mails.

The widespread connection of the subscriber components to the Internet by means of subscriber lines referred to as digital subscriber lines (DSL) means that increasingly also private users and relatively small companies or offices are affected by the aforementioned threats and need to take suitable protective measures against them.

In some measure, deliberate attacks on subscriber components or else on computers in the communication network cause high costs for the respective operator. Damage limitation is more complex the later an attack is identified.

The threats indicated above are fended off on a technical basis by virus scanners, systems for automatically identifying illegal or random access (intrusion detection system IDS), systems for preventing illegal or random access (network intrusion prevention system NIPS or IPS), firewalls, virtual private networks (VPN) and encryption and authentication methods, such as SSH, SSL or TLS.

Typically one or more of the protective measures are used by the user or operator of the subscriber component. This is done by virtue of a firewall being installed between a subscriber component and the communication network, a virus scanner being set up on the subscriber component or a communication link being set up via the communication network by the use of VPN. In this context, the communication network is regarded as a transport medium and an unprotected area.

### SUMMARY OF THE INVENTION

The invention provides a way of protecting subscriber components against threats of the aforementioned type.

In one embodiment of the invention, a network access node computer for a communication network can be connected to the communication network by means of a communication line and to a subscriber component by means of at least one subscriber line. The network access node computer is set up to transport a data stream between the communication network and the at least one subscriber component. It also has a protective apparatus through which the data stream can be routed and which is set up to capture the data stream, to analyze it and to alter it under prescribed conditions.

The network access node computer is a component which concentrates the data streams from a plurality of subscriber components, which are connected to the network access node computer by means of a respective subscriber line, on to a total data stream which is routed via the communication line connecting the network access node computer to the communication network.

In another embodiment of the invention, there are protective mechanisms which have been set up and operated in the subscriber components to date to be moved to the network access node computer. This relieves the operators of the subscriber components of the task of having to deal with protecting their subscriber components themselves. The network access node computers are usually in the sphere of influence of the operator of the communication network, which easily can provide appropriate protective apparatuses. In this case, it is particularly possible for just a single protective apparatus to be used to protect a plurality of subscriber components, namely that number of subscriber components which are connected to the network access node computer.

The protective apparatus may have a plurality of different protective components. In line with one embodiment, the protective apparatus has a firewall functionality as a first protective component. In this case, a firewall can be used on layer 2 or 3 of the OSI reference model. The firewall can then be set up by the operator of the communication network and made available to the subscriber components. Since the operator has only limited information about the subscriber component, it is necessary to make a compromise in the configuration of the firewall for the most frequent cases. In this context, a transparent firewall on layer 2 may be an advantageous solution. This firewall could be used to provide services to protect against unwanted contents, for example. The first protective component may be provided once for all of the subscriber nodes in the protective apparatus. However, it is also conceivable to assign each subscriber component a separate first protective component.

In another embodiment, the protective apparatus has a virus scanner functionality as a second protective component, where the data stream is checked for virus signatures. The second protective component is set up to block the data stream when a virus signature is identified and/or to send a message containing an attribute which signals an alarm. In this context, the alarm can be sent to the sender and/or the receiver of the data stream, that is to say to a computer in the communication network or to the subscriber component.

In still another embodiment of the network access node computer, the protective apparatus has a system for automatically identifying illegal or random access from the communication network to the at least one subscriber component and/or from the at least one subscriber component to the communication network as a third protective component. Such a system is an intrusion detection system (IDS) which can be used to identify attacks, particularly intrusion onto a subscriber component.

In yet another embodiment, the protective apparatus has a system for preventing illegal or random access from the communication network to the at least one subscriber component and/or from the at least one subscriber component to the communication network as a fourth protective component. This system, which is known as a network intrusion protection system (NIPS or IPS), goes beyond identifying an attack and prevents it.

The third and fourth protective components may in this case be combined with one another to form a functional unit.

In another embodiment, provision is made for the network access node computer to be set up to assign the protective apparatus to at least one of the subscriber lines so that the data stream on this at least one subscriber line is routed via the protective apparatus when there is such an assignment. A network access node computer of this kind allows the user of a subscriber component to be provided with technically available protective measures, e.g. as a cost-incurring service. In line with this embodiment, provision is therefore not made for the data stream from each subscriber component to be routed to the communication network via the protective apparatus compulsorily. Rather, the network access node computer may be set up to route the data stream from individual subscriber components via the protective apparatus selectively.

Finer control of the data stream becomes possible by virtue of another embodiment, on the basis of which the network access node computer is set up to assign at least one of the protective components to at least one of the subscriber lines, so that the data stream on this at least one subscriber line is routed via the at least one protective component when there is such an assignment. In line with this refinement, particular protective components can be assigned selectively in various subscriber lines and are then used to route the data stream.

In still another embodiment, provision is made for the first protective component and/or the second protective component and/or the third protective component and/or the fourth protective component to be implemented in hardware and/or in software. The materialization of which of the protective components is implemented in hardware and/or software can be stipulated particularly on the basis of the size (throughput rate) of the data stream. Pure software solutions are recommended for a small proportion of subscriber components or subscriber lines which are to be protected. In this case, the greatest flexibility in the functionality can be expected at low performance. With very high data throughput rates, some functions of the protective components may, by contrast, be undertaken better by a processor and hence an implementation in hardware.

In another embodiment, the network access node computer is a digital subscriber line access multiplexer (DSLAM) which is the access to a broadband communication network for a plurality of subscriber components. The subscriber line is a digital subscriber line (DSL) communication line which connects a subscriber component to the network access node computer.

In still another embodiment of the invention, there is a communication system including a communication network, at least one subscriber component and a network access node computer which is designed as described above. The communication system has the same advantages as have been described above in connection with the network access node computer.

In one embodiment, the subscriber component may be a single computer or a further communication network, e.g. what is known as an intranet or the like. In line with one embodiment, the communication network is a broadband network, particularly an asynchronous transport module (ATM) communication network or Ethernet-based network.

In yet another embodiment of the invention, there is a method for operating a communication system having a communication network, at least one subscriber component and a network access node computer involves a data stream transmitted between the communication network and a subscriber component being captured, analyzed and altered under prescribed conditions in the network access node computer. In other words, the data stream is subjected to a check in the network access node computer for possible threats to the subscriber component and/or the communication network. In particular, provision may be made for the data stream to be analyzed for virus signatures and/or a denial of service (DoS) attack and/or unsolicited bulk e-mail (UBE).

### BRIEF DESCRIPTION OF THE DRAWINGS

The invention is explained in more detail below with reference to the FIGURE, in which:

FIG. 1 illustrates a communication system in accordance with the invention.

### DETAILED DESCRIPTION OF THE INVENTION

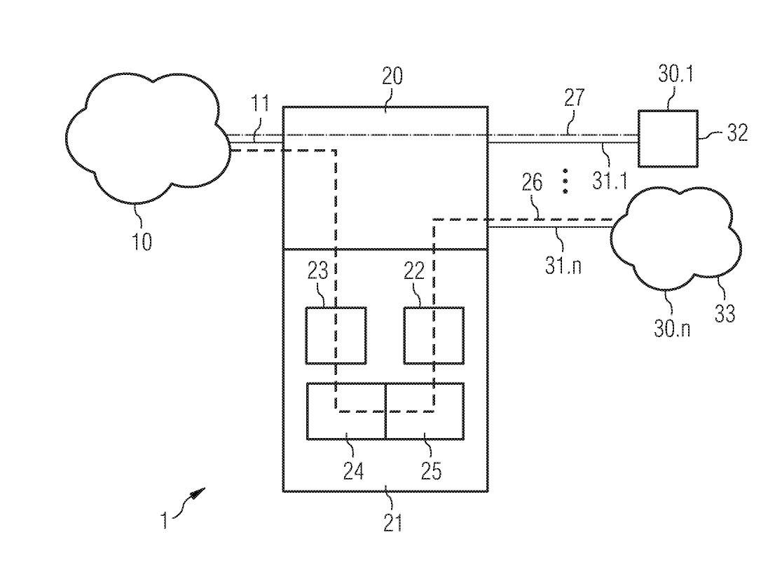

FIG. 1 illustrates a communication system 1 based on the invention. This has a communication network 10, for example, a communication network based on Internet protocols (IP), comprising a multiplicity of computers (not shown) which are coupled to one another. The communication network 10 is coupled to a network access node computer 20, e.g. a digital subscriber line access multiplexer (DSLAM), by means of a communication line 11, which is formed by a broadband line. The network access node computer 20 is in turn coupled to respective subscriber components 30.1, . . . , 30.n by means of a plurality of subscriber lines 31.1, . . . , 31.n, in the known fashion. By way of example, the subscriber component 30.1 is in the form of a single computer 32, while the subscriber component 30.n is formed by a further communication network 33. In the exemplary embodiment, the subscriber lines 31.1, . . . , 31.n are what are known as DSL communication lines.

The network access node computer 20 is a network component for concentrating a plurality of xDSL connections. The network access node computer 20 is an access for the communication network 10 in the form of a broadband network. Its typical tasks include multiplexing and aggregating the data streams, matching the bit rate to the transmission speed of the xDSL connection, providing network management information, setting up permanent virtual connections (permanent virtual circuit PVC), setting up and initiating selective virtual connections (switched virtual circuit SVC) and controlling traffic (policing) in order to ensure a quality of service (QoS).

The network access node computer 20 has a protective apparatus 21 which, in the exemplary embodiment, comprises protective components 22, 23, 24, 25. The individual protective components 22, 23, 24, 25 are isolated from one another, so that there is no possibility of reciprocal influencing. The protective components can be selectively assigned to one or more of the subscriber lines 31.1, . . . , 31.n and hence to the respectively connected subscriber components 30.1, . . . , 30.n.

The data stream between the subscriber component 30.1 and the communication network 10 is identified by means of the reference symbol 27. The data stream between the subscriber component 30.n and the communication network 10 is identified by means of the reference symbol 26.

In the exemplary embodiment, such assignment is made to the subscriber line 31.n and the subscriber component 30.n (communication network 33) coupled thereto. While the data stream 27 is not monitored by any kind of protective mechanisms (unless a protective component is active in the subscriber component 30.1 itself), the data stream 26 routed through the protective apparatus 21 is subjected to all the protective mechanisms of the protective apparatus 21 by way of example. In an embodiment not shown, the data stream 27 could also be routed just through several, previously determined, protective components.

By way of example, the protective component 22 is a firewall. A firewall is generally a concept for network protection at the boundary between two communication networks (in this case communication network 10 and subscriber component 30.n), through which any communication (data stream) between the two networks needs to be routed. Firewalls are used in order primarily to protect a local area network (subscriber component 30.n) against attacks from the Internet (communication network 10). Since the communication between the networks needs to be routed via the firewall in all cases, this allows consistent implementation of a security policy. The protective measures used in this context are effected in both directions, but may also be used asymmetrically, since the subscriber components are trusted more than the users of the communication network 10. The users of the network to be protected therefore take fewer restrictive measures than the external users.

The possible protective measures in a firewall include, inter alia, limitation of the services which can be used in the untrustworthy network, reduction of the number of communication computers to be protected, structured limitation of access rights, filtering of the data stream, an audit function (that is to say monitoring and reproducibility of access operations and data traffic), authentication and identification and also encrypted, enciphered transmission.

A firewall may be implemented either in hardware or in software. It is conceivable to assign a firewall to each of the subscriber lines 31.1, 31.n to be protected, for example.

The protective component 23 may be a virus scanner which is typically implemented in software. An instance of the virus scanner can be allocated to an appropriate subscriber line (in this case: subscriber line 30.n). The virus scanner scans the incoming and outgoing data stream 27 for known virus signatures. When a virus is identified, an alarm can be initiated and the appropriate data stream can be disabled.

The protective component 24 is an intrusion detection system (IDS) which is implemented in the form of software and which can be used to identify attacks on the subscriber component 30.n. Connected to this is the protective component 25, which is in the form of a network intrusion protection system (NIPS) and prevents an identified attack.

The invention can be used advantageously particularly in the field of DSL communication links between respective subscriber components and a communication network. In this case, advantages are obtained both for the user of the subscriber component and for the operator of the communication network.

The user is relieved of the task of having to deal with suitable protective measures for his subscriber component. The complexity involves dealing with the complex of themes of installing suitable protective measures and maintaining or updating the data for the protective measures. For users who do not wish or are unable to deal with this complex of themes, this is a considerable relief. In addition, a dedicated solution affords security advantages, since an attack or else a virus can be fended off actually before it reaches the subscriber component.

The operator of a communication network also has an increasing interest in protecting the communication network against attacks and threats. Viruses, worms, denial of service attacks and the like increasingly result in failures and hence in high costs for the operators of the communication networks. By protecting the subscriber line or the subscriber component coupled thereto, the communication network is protected at the point of entry. This allows attacks to be fended off as early as possible. The invention therefore provides an important module for increasing communication network security.

1. A network access node computer for a communication network, comprising:
a communication line connecting the network access node computer to the communication network and to a subscriber component by at least one subscriber line; and
at least one data stream routed through the network access node computer and between the communication network and the at least one subscriber component, wherein
the network access node computer having a protective apparatus through which the at least one data stream can be routed and which is set up to capture the at least one data stream, to analyze it and to alter it under prescribed conditions.

2. The network access node computer as claimed in claim 1, wherein the protective apparatus has a firewall functionality as a first protective component.

3. The network access node computer as claimed in claim 1, wherein the protective apparatus has a virus scanner functionality as a second protective component, where the data stream is checked for virus signatures.

4. The network access node computer as claimed in claim 3, wherein the second protective component is set up to block the data stream when a virus signature is identified and/or to send a message containing an attribute which signals an alarm.

5. The network access node computer as claimed in claim 1, wherein the protective apparatus has a system for automatically identifying illegal or random access from the communication network to the at least one subscriber component and/or from the at least one subscriber component to the communication network as a third protective component.

6. The network access node computer as claimed in claim 1, wherein the protective apparatus has a system for preventing illegal or random access from the communication network to the at least one subscriber component and/or from the at least one subscriber component to the communication network as a fourth protective component.

7. The network access node computer as claimed in claim 1, wherein the network access node computer is set up to assign the protective apparatus to at least one of the subscriber lines so that the data stream on the at least one subscriber line is routed via the protective apparatus when there is such an assignment.

8. The network access node computer as claimed in claim 7, wherein the network access node computer is set up to assign at least one of the protective components to at least one of the subscriber lines, so that the data stream on the at least one subscriber line is routed via the at least one protective component when there is such an assignment.

9. The network access node computer as claimed in claim 1, wherein the first protective component and/or the second protective component and/or the third protective component and/or the fourth protective component are implemented in hardware.

10. The network access node computer as claimed in claim 1, wherein the first protective component and/or the second protective component and/or the third protective component and/or the fourth protective component are implemented in software.

11. The network access node computer as claimed in claim 1, wherein the network access node computer is a digital subscriber line access multiplexer which is access to a broadband communication network for a plurality of subscriber components.

12. The network access node computer as claimed in claim 1, wherein the subscriber line is a digital subscriber line communication line.

13. A communication system, comprising:
a communication network;
at least one subscriber component;
a network node access computer, comprising a communication line connecting the network access node computer to the communication network and to a subscriber component by at least one subscriber line;
and at least one data stream routed through the network access node computer and between the communication network and the at least one subscriber component, wherein
the network access node computer having a protective apparatus through which the at least one data stream can be routed and which is set up to capture the at least one data stream, to analyze it and to alter it under prescribed conditions.

14. The communication system as claimed in claim 13, wherein at the subscriber component is a single computer or a further communication network.

15. The communication system as claimed in claim 13, wherein
the communication network is an asynchronous transport module communication network.

16. A method for operating a communication system having
a communication network,
at least one subscriber component, and
a network node access computer comprising a communication line connecting the network access node computer to the communication network and to a subscriber component by at least one subscriber line; and at least one data stream routed through the network access node computer and between the communication network and the at least one subscriber component, wherein the network access node computer having a protective apparatus through which the at least one data stream can be routed and which is set up to capture the at least one data stream, to analyze it and to alter it under prescribed conditions,
in which a data stream transmitted between the communication network and a subscriber component is captured, analyzed and altered under prescribed conditions in the network access node computer.

17. The method as claimed in claim 16, wherein the data stream is analyzed for virus signatures and/or denial of service attacks and/or unsolicited bulk e-mail.
